(19) United States
(12) Patent Application Publication
(10) Pub. No.: US 2011/0052109 A1
(43) Pub. Date: Mar. 3, 2011

(54) HYDROSTATIC AUXILIARY BEARING FOR A TURBOMACHINE

(75) Inventors: Joseph Andrew Tecza, Scio, NY (US); Stephen Samuel Rashid, Wellsville, NY (US)

(73) Assignee: DRESSER-RAND COMPANY, Olean, NY (US)

(21) Appl. No.: 12/550,000

(22) Filed: Aug. 28, 2009

(51) Int. Cl. F16C 32/06; F16C 32/00; H02K 7/09

(52) U.S. Cl. 384/101; 384/114; 310/90.5

(57) ABSTRACT

A system for supporting a rotating shaft, including a primary bearing configured to maintain the shaft within a predetermined range of operational shaft positions; a process fluid source; and a hydrostatic auxiliary bearing having an inner surface manufactured from a self lubricating composite material. The hydrostatic auxiliary bearing is fluidically coupled to the process fluid source and configured to use a pressurized process fluid provided by the process fluid source to maintain the shaft within the predetermined range of operational shaft positions when the primary bearing fails to maintain the shaft within the predetermined range of operational shaft positions when the primary bearing fails.

### BACKGROUND

In turbomachine systems, if a primary bearing (such as a magnetic bearing) fails, the shaft of the turbomachine will generally fall or drop onto the adjacent mechanical surfaces. This drop often causes substantial damage to the shaft and/or the surrounding components. In turbomachine systems that include an auxiliary bearing, the shaft may drop onto the auxiliary bearing without damaging the shaft or surrounding components.

There are two common designs for a traditional auxiliary bearing: (a) a dry-lubricated bushing, and (b) one or more rolling element bearing(s) with a clearance between the bearing inner ring(s) and the shaft.

The bushing design consists of one or more segments of a material containing a dry lubricant. When a shaft drops onto this bearing, it slides within the bearing as it coasts down from speed. Considerable heat is generated in this process, which limits the time the rotor can spin on the auxiliary bearing. Furthermore, the bearing surface is subject to wear, and the friction forces on the rotor have the potential for sending it into destructive backward whirl.

With the rolling element bearing design, the shaft drops onto the inside of the bearing inner ring. In this configuration, the auxiliary bearing is accelerated almost instantaneously to match the shaft speed when a drop occurs. The auxiliary bearing may then be used to allow the shaft to coast down on the auxiliary bearing (maintaining normal operating speed is generally not possible). However, this configuration may cause amplitude backward whirl of the shaft, brinelling of the races from the impact of the shaft, skidding between rolling elements and races due to the high acceleration rate of the bearing to match the shaft speed, high stresses in the cage or separator (if employed), and overheating of the auxiliary bearing. Further, the life of auxiliary bearings in this configuration is often only a few drops of the shaft, and as such, the longevity and reliability are challenges.

The lack of a reliable, long-lasting auxiliary bearing technology, also known as “coastdown bearing” or “catcher bearing” technology, has been a barrier to the implementation of magnetic bearings into turbomachines. Magnetic bearings are now being considered for applications where the auxiliary bearing may be required to support the shaft at operating speed for sustained operation when a primary bearing fails (e.g., minutes to days). Thus, there is a need for an auxiliary bearing system or configuration that provides for continued operation of a turbomachine for longer periods of time when a primary bearing fails.

### SUMMARY

Embodiments of the disclosure may provide a system for supporting a rotating shaft, including a primary bearing configured to maintain the shaft within a predetermined range of operational shaft positions; a process fluid source; and a hydrostatic auxiliary bearing having an inner surface manufactured from a self lubricating composite material. The hydrostatic auxiliary bearing is fluidically coupled to the process fluid source and configured to use a pressurized process fluid provided by the process fluid source to maintain the shaft within the predetermined range of operational shaft positions when the primary bearing fails to maintain the shaft within the predetermined range of operational shaft positions when the primary bearing fails.

Embodiments of the disclosure may further provide a method for supporting a rotating shaft, including maintaining the shaft within a predetermined range of operational shaft positions using a primary active magnetic bearing. The method may further include maintaining the shaft within the predetermined range of operational shaft positions using a hydrostatic auxiliary bearing when the primary active magnetic bearing fails to maintain the shaft within the predetermined range of operational shaft positions. The hydrostatic auxiliary bearing is configured to support the shaft using a pressurized process fluid from a process fluid source, and an inner surface of the hydrostatic auxiliary bearing comprises a self lubricating composite material.

Embodiments of the disclosure may further provide a system for supporting a rotating shaft, including first means for maintaining the shaft within a predetermined range of operational shaft positions. The system may further include a second means for maintaining the shaft within a predetermined range of operational shaft positions when the first means fails to maintain the shaft within the predetermined range of operational shaft positions, wherein the second means uses a pressurized process fluid from a means for storing process fluid. An inner surface of the second means comprises a self lubricating composite material.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a schematic view of a turbomachine according to one or more aspects of the present disclosure.

FIG. 2A illustrates a cross-sectional view of an auxiliary or catcher bearing according to one or more aspects of the present disclosure.

FIG. 2B illustrates a partial cross-sectional view of an auxiliary or catcher bearing according to one or more aspects of the present disclosure.

FIG. 2C illustrates a cross-sectional view of another exemplary embodiment of auxiliary or catcher bearing according to one or more aspects of the present disclosure.

FIG. 3A illustrates a schematic view of a turbomachine according to one or more aspects of the present disclosure.

FIG. 3B illustrates a perspective view of a damper seal according to one or more aspects of the present disclosure.

FIG. 3C illustrates a perspective view of a portion of a damper seal according to one or more aspects of the present disclosure.

FIG. 4A illustrates a cross-sectional view of an auxiliary or catcher thrust bearing according to one or more aspects of the present disclosure.

FIG. 4B illustrates a cross-sectional view of a combined auxiliary, or catcher, radial and thrust bearing according to one or more aspects of the present disclosure.

FIG. 4C illustrates a partial cross-sectional view of a combined auxiliary, or catcher, radial and thrust bearing according to one or more aspects of the present disclosure.

FIG. 5 illustrates a flowchart of a method for supporting a shaft of a turbomachine according to one or more aspects of the present disclosure.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope.

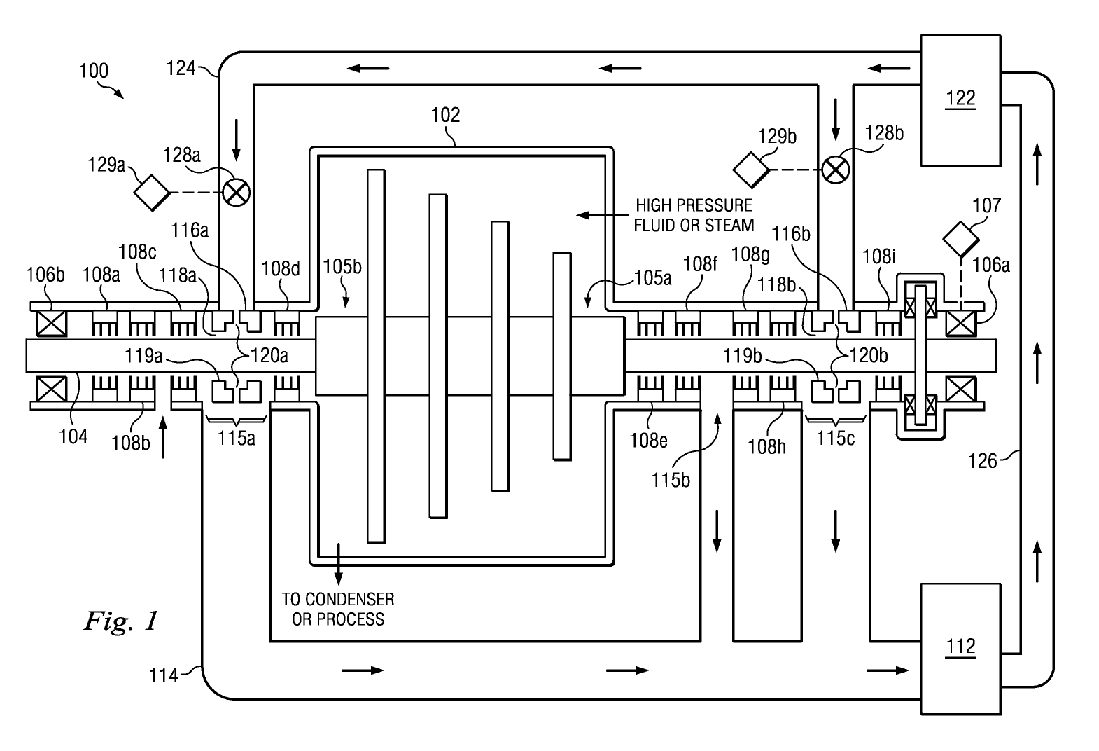

FIG. 1 illustrates a turbomachine 100 in accordance with an exemplary embodiment of the present disclosure. The turbomachine 100 may include a turbine, such as a steam turbine. In an exemplary embodiment, the turbomachine 100 may include a compressor, such as a rotary compressor. In other exemplary embodiments, the turbomachine 100 may be any device that generates energy using a process fluid or process gas, including without limitation a turboset. The turbomachine 100 includes a casing 102, and a shaft 104 positioned within the casing 102. High pressure steam or air surrounds the shaft 104 at a location 105a. Further, steam or air, at low or atmospheric pressure, surrounds the shaft 104 at a location 105b.

Primary bearings 106a and 106b are coupled to respective interior surfaces of the casing 102 at opposing end portions of the shaft 104, and provide support for the shaft 104. Each of the primary bearings 106a and 106b is an active magnetic bearing that has one or more electromagnets controlled by a magnet control 107. The magnet control 107 may also be equipped with one or more sensors configured to monitor operating conditions of the primary bearings 106a and 106b. In an exemplary embodiment, each of the primary bearings 106a and 106b may be a passive magnetic bearing that only includes permanent magnets. In yet another exemplary embodiment, each of the primary bearings 106a and 106b may be a suspension bearing. In other exemplary embodiments, each of the primary bearings 106a and 106b may be any kind of conventional bearing that may fail and cause the shaft to drop or otherwise become positioned out of the normal operation position (axially within the turbomachine). Means for maintaining the shaft within a predetermined range of operational shaft positions may include any of the foregoing embodiments of the primary bearing 106 and any equivalents thereof.

A plurality of labyrinth seal assemblies 108a-i circumferentially surround the shaft 104. In an exemplary embodiment, the labyrinth seal assemblies 108a-i may include one or more labyrinth seal segments that form one or more labyrinth packing rings. The labyrinth seal segments may be segmented cylindrical-toothed rings. Other designs for labyrinth seal assemblies 108a-i that are known in the art are also within the scope of the present disclosure. A leakage recycler 112 is fluidically coupled to a leakage recycler pipe 114. The leakage recycler pipe 114 is also be fluidically coupled to openings 115a-c formed in the casing 102. In other exemplary embodiments, other configurations for positioning the leakage recycler pipe 114 may also be used without departing from the scope of the present disclosure.

The turbomachine 100 also includes auxiliary or catcher bearings 116a and 116b that circumferentially surround the shaft 104. The auxiliary bearing 116a is located between the labyrinth seal assemblies 108c and 108d. The auxiliary bearing 116b is located between labyrinth seal assemblies 108h and 108i. In an exemplary embodiment, the auxiliary bearings 116a and 116b may include a hydrostatic bearing. A hydrostatic bearing is also sometimes referred to as a fluid film bearing. In an exemplary embodiment, a clearance 118a may be formed between an inner surface 119a of the auxiliary bearing 116a and the shaft 104, and a clearance 118b may be formed between an inner surface 119b of the auxiliary bearing 116b and the shaft 104.

In an exemplary embodiment, the inner surface 119 may include material that consists of a durable surface, such as NASA PS300. As disclosed in U.S. Pat. No. 5,866,518, NASA PS300 is a self lubricating, friction-reducing, and wear-reducing composite material. U.S. Pat. No. 5,866,518 is herein incorporated in its entirety to the extent it does not contradict the present disclosure. In another exemplary embodiment, the inner surface 119a or 119b may include a hard coating such as chrome oxide or titanium nitride, and may include materials such as clutch material, brake material, and sintered material.

In an exemplary embodiment, the auxiliary bearings 116a and 116b include inlets 120a and 120b, respectively, which are fluidically coupled to a process fluid source 122 via a process fluid pipe 124. The fluid source 122 may provide boiler feedwater to the inlets 120a and 120b via the process fluid pipe 124. Further, the leakage recycler 112 is fluidically coupled to the process fluid source 122 via a recirculation pipe 126. In other exemplary embodiments, multiple recirculation pipes 126 may fluidically couple the leakage recycler 112 to the process fluid source 122. Also, a system recycle pipe (not shown) may fluidically couple the leakage recycler 112 to other components of the turbomachine 100 that are not shown in FIG. 1.

The process fluid pipe 124 is configured to operate with valves 128a and 128b. The valves 128a and 128b have valve controls 129a and 129b, respectively, which are configured to control the valves 128a and 128b. A master control system (not shown) may be communicably coupled to the valve controls 129a and 129b and the magnet control 107. One or more wires may facilitate communication between the master control system, the valve controls 129a and 129b, and the magnet control 107.

Turning now to the operation of the turbomachine 100, in an exemplary embodiment, the primary bearings 106a and 106b maintain the shaft 104 within a predetermined range of operational shaft positions. When the magnet control 107 detects that the primary bearing 106a or 106b is failing to maintain the shaft 104 within the predetermined range of operational shaft positions, the magnet control 107 sends a signal to the valve controls 129a-b to open the valves 128a-b.

In another exemplary embodiment, one or more sensors (not shown) may be used to monitor the operation conditions of the turbomachine 100. The valve controls 129-b may be configured to communicate with the sensors, and open the valves 128a-b when a predetermined set of operating conditions is detected by the sensors. For example, in one embodiment, the valve controls 129a-b cause the valves 128a-b to open when a sensor detects that the temperatures of the inner surfaces 119a-b of the auxiliary bearings 116a-b have reached a predetermined temperature that indicates that the shaft 104 is outside of a predetermined range of operational shaft positions, i.e., that a drop is about to occur or is occurring.

In yet another exemplary embodiment, one or more sensors may track the center of the shaft 104, and may instruct the valve controls 129a-b to open the valves 128a-b when the sensors detect that the center of the shaft 104 is outside a predetermined range of operational shaft positions. In another exemplary embodiment, the auxiliary bearings 116a-b may be configured to idle at a predetermined hydrostatic pressure that may be lower than an operating pressure of the bearings, so that the auxiliary bearings 116a-b may become fully operational (brought up to operating pressure) more quickly when the valves 128a-b are opened. Other methods for determining when to open the valves 128a-b are also within the scope of the present disclosure.

In an exemplary embodiment, when the valves 128a-b are open, high-pressure process fluid may be provided from the process fluid source 122 to the inlets 120a-b via the process fluid pipe 124. Upon entering the inlets 120a-b, the process fluid may form a fluid film between the shaft 104 and the inner surfaces 119a-b. The hydrostatic pressure of the fluid film may maintain the shaft 104 within a predetermined range of operational shaft positions.

In an exemplary embodiment, the pressure of the process fluid may be less than about 1000 psi. In another exemplary embodiment, the pressure of the process fluid may range from about 500 psi to about 900 psi, and may preferably be about 750 psi. Other process fluid pressure ranges are also within the scope of the present disclosure. The process fluid may be maintained at a temperature that will not flash with a pressure drop that exists outside of the auxiliary bearings 116a-b.

In an exemplary embodiment, the process fluid may be water. A high pressure feed pump or an emergency high-pressure pump may provide the water to the auxiliary bearings 116a-b in liquid form. The water may also be made available to the auxiliary bearings 116a-b in gaseous form as high-pressure steam. According to an exemplary embodiment, the water may be feedwater from a Rankine cycle turbomachine. In yet another exemplary embodiment, the process fluid may be ethylene glycol. It should be understood that a gas, such as air or an inert gas, may also be used as a process gas instead of using a process fluid.

According to an exemplary embodiment, process fluid leakage may pass through the auxiliary bearings 116a-b via the clearances 118a-b. The leakage may be restricted by the labyrinth seal assemblies 108a-i and may be directed via the leakage recycler pipe 114 to the leakage recycler 112. The leakage recycler 112 may recycle the leakage. Recycling the leakage may include cooling the leakage, as well as performing other operations on the leakage so that it may be reused as process fluid. Upon recycling the leakage, a portion of the recycled leakage may be directed to the process fluid source 122 via the recirculation pipe 126. Further, the recycled leakage may be directed to other components of the turbomachine 100 via a system recycle pipe. In an exemplary embodiment, the leakage recycler 112 may include a condenser configured to cool the leakage. However, other means for recycling leakage are also within the scope of the present disclosure.

In several exemplary embodiments, auxiliary bearings that are substantially similar to the bearing 106a or 106b may circumferentially surround other portions of the shaft 104.

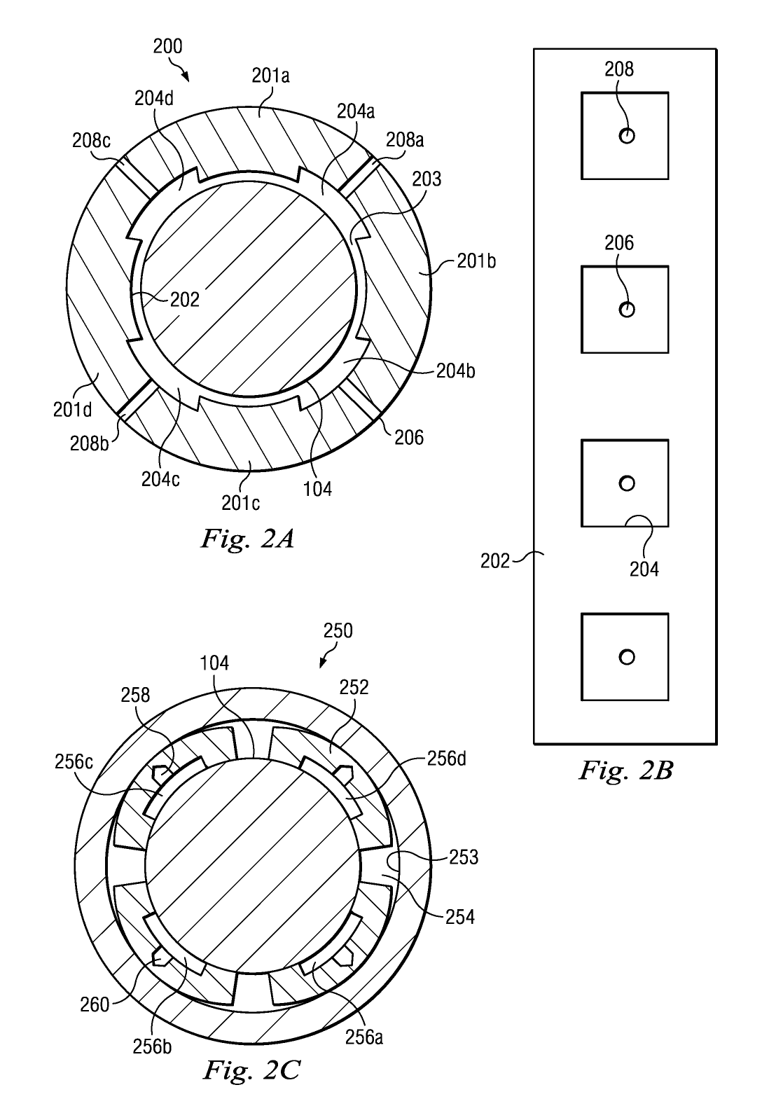

Referring now to FIG. 2A, the auxiliary bearing 116a or 116b of FIG. 1 may be a pocketed auxiliary bearing 200. In an exemplary embodiment, the pocketed auxiliary bearing 200 includes one or more bearing segments 201a-d arranged around the shaft 104. Each segment 201a-d includes an inner surface 202 that faces the shaft 104.

A clearance 203 is formed between the inner surface 202 of the pocketed auxiliary bearing 200 and the shaft 104. Various clearance 203 widths may be used. A decreased clearance 203 width may result in decreased fluid flow between the outer surface of the shaft 104 and the inner surface 202 of the pocketed auxiliary bearing 200. In another exemplary embodiment, an increased clearance 203 width may result in increased fluid flow between the shaft 104 and the inner surface 202. In one exemplary embodiment, the size of the clearance 203 may vary depending on the weight of the shaft 104. The pocketed auxiliary bearing 200 includes one or more pockets 204a-d formed along the inner surface 202. Each of the pockets 204a-d are formed across two adjacent bearing segments 201a-d.

One or more inlets 206 are formed between circumferentially adjacent bearing segments 201a-d. The inlet 206 may correspond to either inlet 120a or inlet 120b in FIG. 1. One or more orifices 208a-c are formed between two adjacent segments 201a-d.

Each pocket 204a-d may be fed with a high-pressure process fluid via the inlet 206. Each orifice 208a-c may regulate process fluid flow and prevent the effects of pressure changes in one pocket 204a-d from affecting another pocket 204a-d, as described below. In another exemplary embodiment, other means may also be used to regulate the flow of process fluid and prevent the effects of pressure changes within a pocket 204a-d from affecting another pocket 204a-d.

In an exemplary embodiment, when the pocketed auxiliary bearing 200 receives process fluid, the resulting fluid film may cause the shaft 104 to adjust its position within a predetermined range of operational shaft positions. During operation of the pocketed auxiliary bearing 200, radial and/or axial forces may cause the shaft 104 to move out of a predetermined range of operational shaft positions. For example, if the shaft 104 moves toward the pocket 204c, such movement may cause a reduction in process fluid leakage out of the pocket 204c via the orifice 208b. Such reduction in leakage may cause the pressure within the pocket 204c to rise. As a result, the clearance 203 between the pocket 204a and shaft 104 may increase. A balancing reaction may cause leakage out of the pocket 204a via the orifice 208a to increase. This increase in leakage out of the pocket 204a may counteract the increased pressure in pocket the 204c. Similar balancing reactions occurring at each of the pockets 204a-d may maintain the shaft 104 within the predetermined range of operational shaft positions.

FIG. 2B shows a partial cross-sectional view of the inner surface 202 of the pocketed auxiliary bearing 200. If the pocketed auxiliary bearing 200 were to be unrolled and laid flat, the inner surface 202 of the pocketed auxiliary bearing 200 may appear similar to the view shown in FIG. 2B.

Referring now to FIG. 2C, illustrated is another exemplary embodiment 250 of the previously described pocketed auxiliary bearing 200. In the illustrated embodiment, an inner surface 253 of the pocketed auxiliary bearing 250 may form a uniform clearance 254 with respect to the shaft 104. A series of tilting pads 252 may be positioned within the clearance 254, and the series of tilting pads 252 may form one or more pockets 256a-d. The series of tilting pads 252 may be evenly spaced, and may circumferentially surround the shaft 104. Each tilting pad 252 may include either an orifice 258 and/or an inlet 260 that is fluidically communicable with each of the pockets 256a-d. In an exemplary embodiment, the pocketed auxiliary bearing 250 may be commercially available through the Waukesha Bearing Corporation.

The operation of the pocketed auxiliary bearing 250 may be similar to the operation of the pocketed auxiliary bearing 200, except that the tilting pads 252 may adjust its position within the clearance 254 to help maintain the shaft 104 within a predetermined range of operational shaft positions.

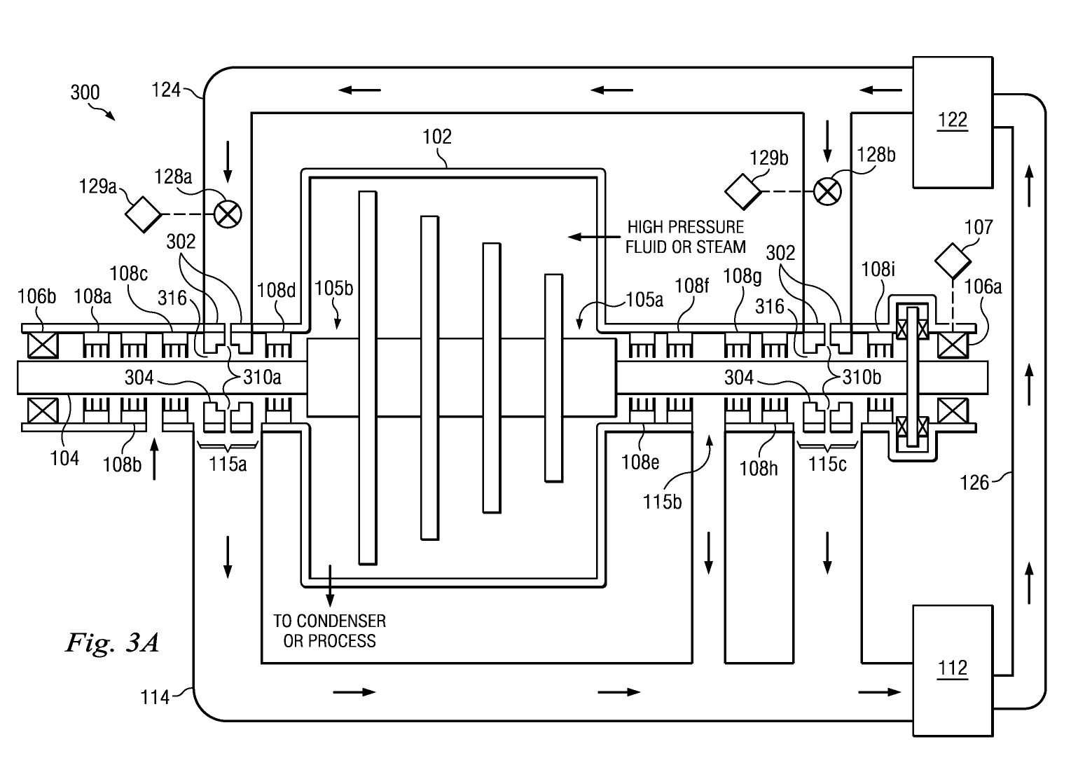

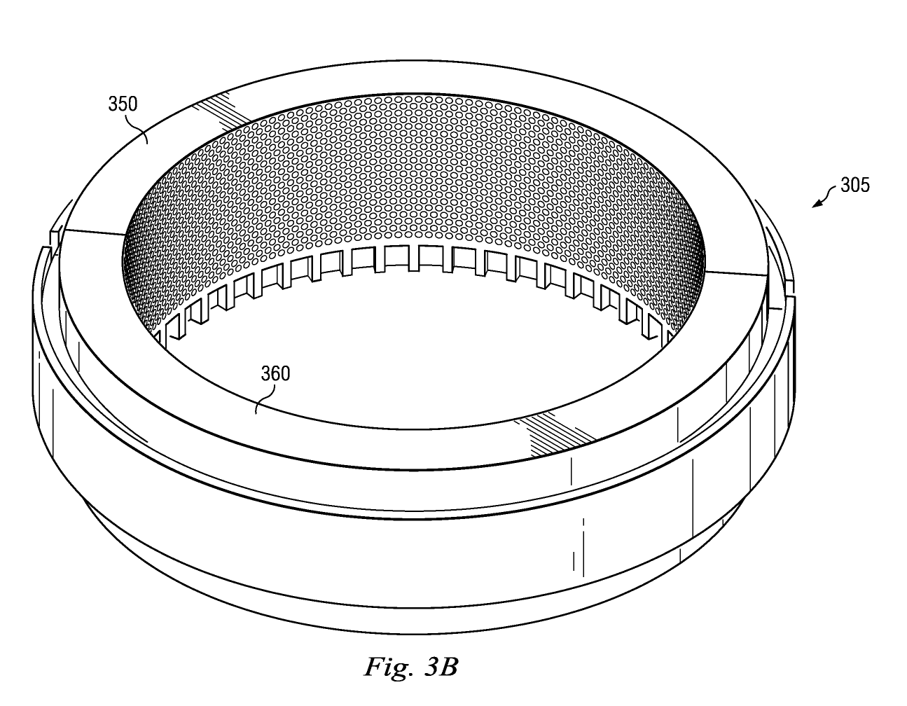

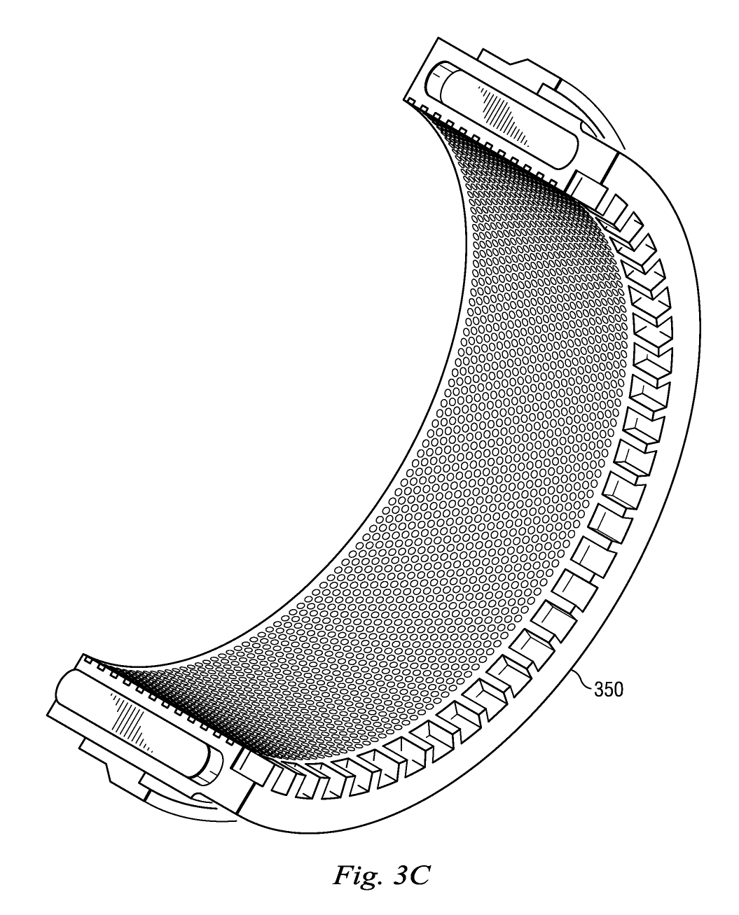

Referring now to FIG. 3A, with continued reference to FIG. 1, a turbomachine 300 is shown. In the turbomachine 300, pairs of bushings 302 serve as auxiliary bearings and may be referred to as “axially-fed auxiliary bearings.” Each of the bushings 302 may have a smooth or patterned inner surface 304.

In an exemplary embodiment, each of the bushings 302 may define a pattern of small apertures on its inner surface 304. The small holes may either be circular, honeycomb-shaped, or any other shape. Such bushings 302 may be referred to as “damper seals.”

In an exemplary embodiment, the bushings 302 circumferentially surround the shaft 104. The bushings 302 may be installed in a back-to-back arrangement between, for example, the labyrinth seal assemblies 108c and 108d, and between the labyrinth seal assemblies 108h and 108i, as illustrated in FIG. 3A. Inlets 310a and 310b are formed between the respective bushings 302 along the shaft 104. The inlets 310a-b are fluidically coupled to the process fluid source 122 containing process fluid. Respective clearances 316 may exist between the respective inner surfaces 304 of the bushings 302, and the outer surface of the shaft 104.

With continuing reference to FIG. 3A, according to an exemplary embodiment of operation, if the primary bearing 106a or 106b fails, the control system 107 instructs the valve controls 129a-b to open the valves 128a-b. When the valves 128a-b are open, the process fluid source 122 supplies a process fluid to the inlets 310a-b.

When the process liquid has entered the inlets 310a-b, the process fluid axially flows across the bushings 302 towards regions of lower pressure. Leakage may be restricted by the labyrinth seal assemblies 108a-i, and may be directed to the leakage recycler 112 via the leakage recycler pipe 114. When leakage reaches the leakage recycler 112, the leakage recycler 112 recycles the leakage and directs the recycled leakage to the process fluid source 122 via the recirculation pipe 126. In an exemplary embodiment, the leakage recycler 112 may include a condenser configured to cool the leakage. Furthermore, a system recycle pipe (not shown) may fluidically couple the leakage recycler 112 to other components of the turbomachine 300 that are not shown in FIG. 3A.

Embodiments of an axially-fed auxiliary bearing may be less efficient than embodiments of the pocketed bearing 200. However, the use of design tools combined with application experience may increase the efficiency of an embodiment of the axially-fed auxiliary bearing 302.

According to an exemplary embodiment, shaft resonance may determine whether a auxiliary bearing has the radial stiffness and damping required for use in the turbomachine 100 or 300. During the operation shaft on the auxiliary bearings the natural frequencies of the rotor-bearing system, and therefore the critical speeds, may change because both the location and stiffnesses of the rotor supports change. Likewise, the dynamic amplification factors for vibration at a critical speed or resonant frequency also may change due to the changes in support location, stiffness and damping. Due to these factors, it may be desirable or necessary to avoid operating at or near a critical speed while the rotor is supported on the auxiliary bearings. Therefore, during the operation of the turbomachine 100 or 300, the shaft 104 may be maintained at an operational speed that does not either surpass or encompass a critical speed where shaft resonance will exist.

FIG. 3B shows a perspective view of a damper seal according to one or more aspects of the present disclosure. More specifically, FIG. 3B shows the stator part of a hole-pattern damper seal 305 according to an exemplary embodiment. The damper seal 305 may be made of aluminum. In other exemplary embodiments, other materials may be used depending on operating temperature and the nature of the process fluid used in the turbomachine 100 or 300. For example, the damper seal 305 may be made of graphitic cast iron and various polymers. Further, the damper seal 305 may be made of Hastalloy or stainless steel. A damper seal 305 may develop substantial radial stiffness when a large pressure drop occurs axially across the damper seal. As shown in FIG. 3B, the damper seal 305 includes a portion 350 and a portion 360 coupled thereto. FIG. 3C shows a perspective view of the portion 350 of the damper seal 305 according to an exemplary embodiment.

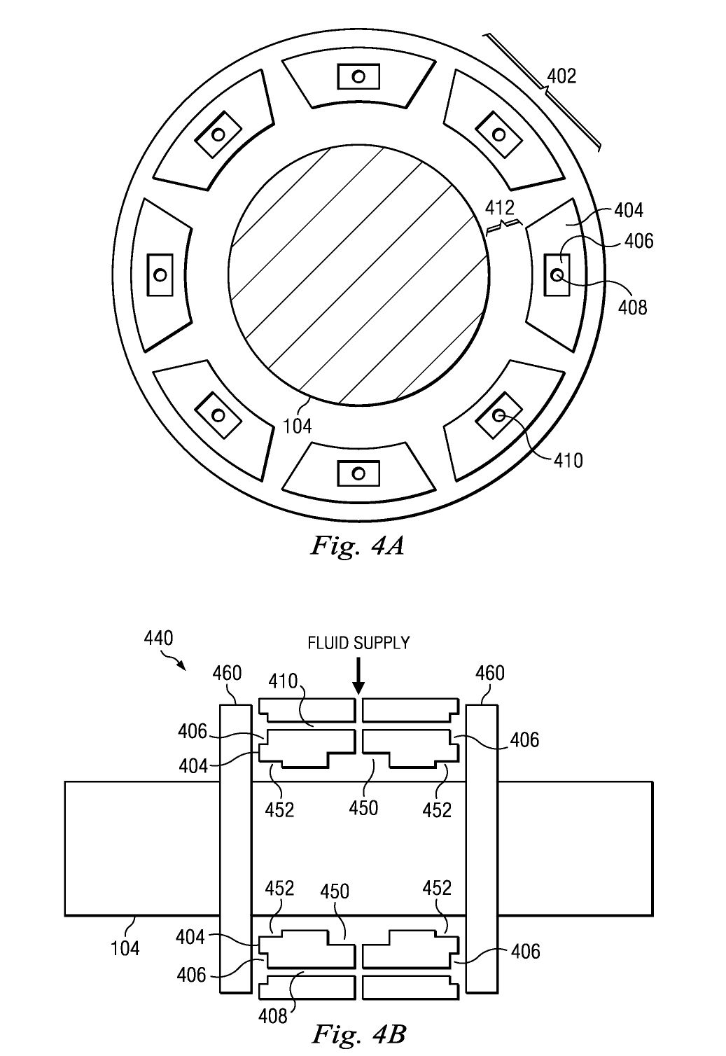

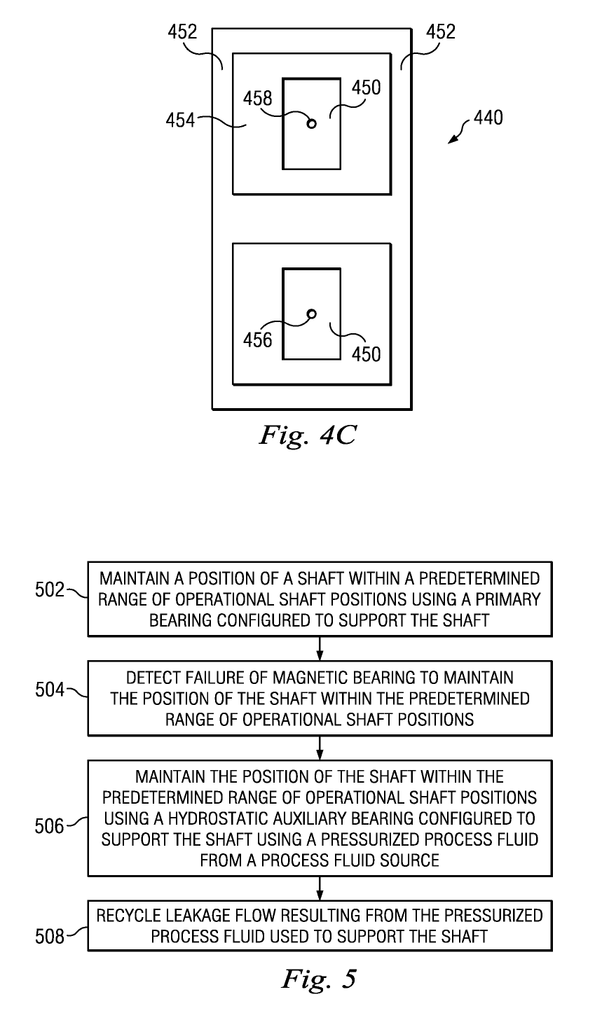

Referring now to FIG. 4A, illustrated is an exemplary embodiment of a hydrostatic auxiliary thrust bearing 400, which includes a plurality of segments 402. According to an exemplary embodiment, the segments 402 may be evenly spaced, and the segments 402 may be adapted to circumferentially surround the shaft 104. The segments 402 may be in the shape of a trapezoid. In other exemplary embodiments, the segments 402 may include any other shapes. Each segment 402 includes an inner surface 404, one or more pockets 406, one or more orifices 408, and one or more inlets 410. In an exemplary embodiment, the segments 402 may be positioned around the shaft 104 so that a top portion of each of the segments 402 forms an equidistant clearance 412 from the outer surface of the shaft 104. In operation, an auxiliary thrust bearing may be placed along other portions of the shaft 104, so long as its position allows the auxiliary thrust bearing 400 to counteract axial forces that may exist when the primary bearing 106 fails. The operation of an auxiliary thrust bearing 400 may be similar to the operation of the pocketed auxiliary bearing 200 described above, except that the auxiliary thrust bearing 400 will work to maintain the position of the shaft 104 within predetermined operating ranges with respect to axial forces, rather than radial forces. In an exemplary embodiment, each of the inner surfaces 404 of the hydrostatic auxiliary thrust bearing 400 may include any material that forms a durable surface, such as NASA PS300.

In an exemplary embodiment, the auxiliary bearing 116a and/or 116b of the turbomachine 100 includes a combined auxiliary radial and thrust bearing. FIG. 4B illustrates a schematic view of a combined auxiliary radial and thrust bearing 440 according to one or more aspects of the present disclosure. As shown in FIG. 4B, the combined auxiliary radial and thrust bearing 440 includes the surface 404, the side pocket 406, the orifice 408, the inlet 410, a radial pocket 450, and a drain groove 452. The combined auxiliary radial and thrust bearing 440 is positioned within a thrust collar 460. The combined auxiliary radial and thrust bearing 440 supports both radial and thrust loads. FIG. 4C illustrates a partial cross-sectional view of the combined auxiliary radial and thrust bearing 440; if the combined auxiliary radial and thrust bearing 440 were to be unrolled and laid flat, the bearing 440 may appear similar to the view shown in FIG. 4C. As shown in FIG. 4C, the bearing 440 includes an inner surface 454, an inlet 456 and an orifice 458.

Referring now to FIG. 5, illustrated is a flowchart that describes a method for supporting a shaft of a turbomachine according to an exemplary embodiment of the present disclosure. The method includes maintaining a position of a shaft 104 within a predetermined range of operational shaft positions using a primary bearing configured to support the shaft, as shown in step 502. The primary bearing may be a magnetic bearing.

If the primary bearing fails to maintain the shaft within the predetermined range of operational shaft positions, such as when the shaft drops as a result of a failed primary bearing (step 504), a control system may immediately engage a hydrostatic auxiliary bearing before the shaft drops onto the inner surface of the hydrostatic auxiliary bearing, so as to maintain the position of the shaft within the predetermined range of operational shaft positions, as shown in step 506. In one exemplary embodiment, the auxiliary bearing may be configured to idle at a predetermined pressure during the operation of the primary bearing, so that the auxiliary bearing may become fully operational more quickly when the primary bearing fails.

The hydrostatic auxiliary bearing may be configured to support the shaft using a pressurized process fluid, such as water or ethylene glycol, that may be provided by a process fluid source. It should be understood that a gas, such as air or an inert gas, may also be used as a process gas instead of using a process fluid. Means for maintaining the shaft within a predetermined range of operational shaft positions when the primary bearing fails to maintain the shaft within the predetermined range of operational shaft positions, may include the auxiliary bearings 116a and 116b, the pocketed auxiliary bearings 200 and 250, axially-fed auxiliary bearings, such as the bushings 302, and any equivalents of the foregoing.

Any leakage resulting from the pressurized process fluid used to support the shaft may be recycled, as shown at step 508. In an exemplary embodiment, the leakage recycler may include a condenser configured to cool the leakage before directing the leakage to the process fluid source.

Generally, hydrostatic bearings have not been utilized as auxiliary bearings in conventional technology, because the lubrication systems (e.g., oil tank, coolers pumps, etc.) that are necessary to provide lubrication to a hydrostatic auxiliary bearing are usually not included in turbomachinery that uses magnetic bearings. Instead of utilizing traditional lubrication systems, the exemplary embodiments set forth in the present disclosure utilize process fluid that is readily available. Further, in the exemplary embodiments disclosed herein, the process fluid may be recycled for use in other areas of a turbomachine. Taking advantage of a readily available process fluid and recycling the process fluid for other uses may result in substantial cost savings.

Potential advantages of the auxiliary bearing embodiments described above over conventional technology may include simplified integration into established bearing technology. The current availability of design tools is one factor that makes this possible. Another potential advantage of the exemplary embodiments described herein may be longer system operating life. The exemplary embodiments of the present disclosure may also exhibit increased load capacity potential.

Turbomachinery implementing the exemplary embodiments disclosed herein may be more compact than conventional turbomachinery using hydrostatic auxiliary bearings, because a variety of process fluids may be used as bearing lubricant. Exemplary embodiments of the present disclosure may be physically smaller and less complex than conventional technology, because traditional lubricant pumping technology is not necessary when process fluid is used as the bearing lubricant. Further, the exemplary embodiments disclosed in the present disclosure allow for process fluid to be recycled after the process fluid is used as bearing lubricant. Recycling process fluid may improve efficiency and lower turbomachinery operating costs.

Although the present disclosure has described embodiments relating to specific turbomachinery, it is understood that the apparatus, systems and methods described herein could applied to other environments. For example, according to another exemplary embodiment, rotating machinery that is driven by a turbomachine may be configured to use embodiments of the auxiliary bearings described above. However, in such applications, the machinery may have to be modified to ensure that the process fluid leaks do not adversely affect the machine.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A system for supporting a rotating shaft, comprising:
a primary bearing configured to maintain the shaft within a predetermined range of operational shaft positions;
a process fluid source; and
a hydrostatic auxiliary bearing having an inner surface manufactured from a self lubricating composite material, wherein the hydrostatic auxiliary bearing is fluidically coupled to the process fluid source and configured to use a pressurized process fluid provided by the process fluid source to maintain the shaft within the predetermined range of operational shaft positions when the primary bearing fails to maintain the shaft within the predetermined range of operational shaft positions when the primary bearing fails.

2. The system of claim 1, wherein the primary bearing comprises a magnetic bearing.

3. The system of claim 1, wherein the hydrostatic auxiliary bearing comprises a pocketed auxiliary bearing.

4. The system of claim 3, wherein the pocketed auxiliary bearing comprises one or more tilting pads.

5. The system of claim 1, wherein the hydrostatic auxiliary bearing comprises an axially-fed auxiliary bearing.

6. The system of claim 5, wherein the axially-fed auxiliary bearing comprises a plurality of damper seals.

7. The system of claim 1, wherein the pressurized process fluid comprises water or ethylene glycol.

8. The system of claim 1 further comprising a leakage recycler fluidically coupled to the process fluid source, wherein the leakage recycler is configured to collect leakage resulting from the hydrostatic auxiliary bearing, recycle the leakage, and direct a portion of the recycled leakage to the process fluid source.

9. The system of claim 8, wherein the leakage recycler comprises a condenser configured to cool the leakage.

10. A method for supporting a rotating shaft, comprising:
maintaining the shaft within a predetermined range of operational shaft positions using a primary active magnetic bearing; and
maintaining the shaft within the predetermined range of operational shaft positions using a hydrostatic auxiliary bearing when the primary active magnetic bearing fails to maintain the shaft within the predetermined range of operational shaft positions, wherein the hydrostatic auxiliary bearing is configured to support the shaft using a pressurized process fluid from a process fluid source, and an inner surface of the hydrostatic auxiliary bearing comprises a self lubricating composite material.

11. The method of claim 10, wherein the hydrostatic auxiliary bearing comprises a pocketed auxiliary bearing.

12. The method of claim 10, wherein the pocketed auxiliary bearing comprises one or more tilting pads.

13. The method of claim 10, wherein the hydrostatic auxiliary bearing comprises an axially-fed auxiliary bearing.

14. The method of claim 13, wherein the axially-fed auxiliary bearing comprises a plurality of damper seals.

15. The method of claim 10, wherein the pressurized process fluid comprises water or ethylene glycol.

16. The method of claim 10 further comprising collecting leakage resulting from the hydrostatic auxiliary bearing at a leakage recycler fluidically coupled to the process fluid source;
recycling the leakage; and
directing a portion of the recycled leakage to the process fluid source.

17. The method of claim 16, wherein the leakage recycler is a condenser, and recycling the leakage comprises cooling the leakage before directing a portion of the recycled leakage to the process fluid source.

18. A system for supporting a rotating shaft, comprising:
first means for maintaining the shaft within a predetermined range of operational shaft positions; and
second means for maintaining the shaft within a predetermined range of operational shaft positions when the first means fails to maintain the shaft within the predetermined range of operational shaft positions, wherein the second means uses a pressurized process fluid from a means for storing process fluid, and an inner surface of the second means comprises a self lubricating composite material.

19. The system of claim 18, wherein the pressurized process fluid comprises at least one of water or ethylene glycol.

20. The system of claim 18 further comprising a leakage recycling collection system configured to collect leakage resulting from the hydrostatic auxiliary bearing that is fluidically coupled to the process fluid source;
a recycling system configured to recycle the leakage; and
a transport system configured to direct a portion of the recycled leakage to the means for storing process fluid.

21. The system of claim 20, wherein the recycling system comprises a condenser that is configured to cool the leakage.
